(19) United States
(12) Patent Application Publication
(10) Pub. No.: US 2016/0261987 A1
(43) Pub. Date: Sep. 8, 2016

(54) VLC-BASED VECTOR FIELD FINGERPRINT MAPPING

(71) Applicant: QUALCOMM Incorporated, San Diego, CA (US)

(72) Inventors: Aleksandar JOVICIC, Jersey City, NJ (US); Shrinivas KUDEKAR, Somerville, NJ (US)

(21) Appl. No.: 14/966,293

(22) Filed: Dec. 11, 2015

Related U.S. Application Data
(63) Continuation of application No. 14/959,681, filed on Dec. 4, 2015.
(60) Provisional application No. 62/127,527, filed on Mar. 3, 2015.

(51) Int. Cl. H04W 4/02

(52) U.S. Cl. CPC H04W 4/026; H04W 4/043

(57) ABSTRACT

A method of determining data of a magnetic field fingerprint map includes: determining, at a server, a transformation of a mobile-device coordinate system of a mobile device to a reference coordinate system using roll information, pitch information, and yaw information of the mobile device relative to the reference coordinate system; obtaining, at the server, first indications of vector components of a magnetic field at a location of the mobile device, the first indications of vector components of the magnetic field being in the mobile-device coordinate system; and determining, at the server, second indications of vector components of the magnetic field using the first indications of vector components of the magnetic field and the transformation, the second indications of vector components of the magnetic field being indicative of vector components of the magnetic field at the location of the mobile device in the reference coordinate system.

### CROSS-REFERENCE TO RELATED APPLICATIONS

This application is a continuation of U.S. application Ser. No. 14/959,681, filed Dec. 4, 2015, entitled “VLC-BASED VECTOR FIELD FINGERPRINT MAPPING,” which claims the benefit of U.S. Provisional Application No. 62/127,527, filed Mar. 3, 2015, entitled “VLC-BASED VECTOR FIELD FINGERPRINT MAPPING,” both of which are assigned to the assignee hereof and are incorporated herein by reference.

### BACKGROUND

Determination of the orientation of a mobile device in indoor environments may be useful in a number of applications. For example, the orientation of a mobile device may be needed to navigate mobile phone users in office/commercial environments, to enable customers to find items in a supermarket or retail outlet, for coupon issuance and redemption, and for customer service and accountability. However, achieving precise orientation estimates in indoor venues is a challenging task. Mobile devices typically estimate their orientation using a compass that is built in to the mobile devices. Such orientation estimates, however, are often highly inaccurate due to the presence of metallic objects inside walls, door frames, and furniture in most indoor venues.

Determination of the position of a mobile device in indoor environments may also be useful. For example, a position of a mobile device may be used for providing directions to a point of interest, providing information regarding products and/or services nearby, or providing other location-based services. To this end, heatmaps indicating the signal strength corresponding to one or more Wi-Fi access points may be used in conjunction with received signals to determine a position of a mobile device.

Building heatmaps is often challenging in terms of resources and/or accuracy. Typically, building heatmaps uses manual surveying of an environment to be mapped, which is a time-consuming and expensive endeavor. Crowdsourcing may be used to generate a heatmap, which reduces the expense of manual surveying, but lacks accuracy compared to manual surveying, e.g., lacking accurate yaw information from mobile devices providing the crowdsourced information.

### SUMMARY

Example methods, computer program products, and apparatus are provided. An example apparatus captures one or more images of at least a first indicator and a second indicator, identifies the first indicator based on first identifying information and identifies the second indicator based on second identifying information, and determines an orientation of the mobile device based on the captured one or more images of the at least the first indicator and the second indicator.

An example method of determining data of a fingerprint map includes: obtaining visible light communication signals at a mobile device; determining an indication of yaw of the mobile device relative to a reference coordinate system using the visible light communication signals; obtaining an indication of roll of the mobile device relative to the reference coordinate system; obtaining an indication of pitch of the mobile device relative to the reference coordinate system; determining a transformation of a mobile-device coordinate system of the mobile device to the reference coordinate system using the indication of roll, the indication of pitch, and the indication of yaw of the mobile device relative to the reference coordinate system; obtaining first indications of vector components of a field at a location of the mobile device, the vector components of the field defining the field; and sending, to a server, the first indications of vector components of the field and the transformation; or determining second indications of vector components of the field using the first indications of vector components of the field and the transformation, the second indications of vector components of the field being indicative of vector components of the field at the location of the mobile device in the reference coordinate system, and sending, to the server, the second indications of vector components of the field; or sending the first indications of vector components of the field to the server, determining the second indications of vector components of the field using the first indications of vector components of the field and the transformation, and sending the second indications of vector components of the field to the server.

Implementations of such a method may include one or more of the following features. The first indications of vector components of the field include an indication of each of an x-component, a y-component, and a z-component of the field in the mobile-device coordinate system, and the second indications of vector components of the field include an indication of each of an x-component, a y-component, and a z-component of the field in the reference coordinate system. Obtaining the first indications of vector components of the field includes measuring respective magnetic field components. Obtaining the indication of roll of the mobile device comprises obtaining measurements from a gyroscope and an accelerometer of the mobile device and sending the indication of roll to the server, obtaining the indication of pitch of the mobile device comprises obtaining measurements from the gyroscope and the accelerometer of the mobile device and sending the indication of pitch to the server, and determining the second indications of vector components of the field comprises the server determining the second indications of vector components of the field. The method comprises determining the second indications of vector components of the field, and the method further includes: obtaining the location of the mobile device corresponding to the first indications of vector components of the field; and combining the second indications of vector components of the field at the location of the mobile device with other second indications of vector components of the field with a location proximate to the location of the mobile device to determine aggregate indications of vector components of the field associated with the location of the mobile device. The method further includes: sending the aggregate indications of vector components of the field associated with the location of the mobile device to the server; and receiving the fingerprint map from the server, the fingerprint map corresponding to a venue including the location of the mobile device. Obtaining the visible light communication signals at the mobile device comprises capturing black-and-white images with an exposure duration of less than 100 microseconds. Obtaining the visible light communication signals at the mobile device includes capturing images with a resolution of no more than 400,000 pixels. The method further includes determining the location of the mobile device using the visible light communication signals.

An example mobile device includes: a camera configured to obtain visible light communication signals; a first orientation sensor configured to obtain an indication of roll of the mobile device relative to a reference coordinate system; a second orientation sensor configured to obtain an indication of pitch of the mobile device relative to the reference coordinate system; and a processor communicatively coupled to the camera, to the first orientation sensor, and to the second orientation sensor and configured to: determine an indication of yaw of the mobile device relative to the reference coordinate system using the visible light communication signals; determine a transformation of a mobile-device coordinate system of the mobile device to the reference coordinate system using the indication of roll, the indication of pitch, and the indication of yaw of the mobile device relative to the reference coordinate system; obtain first indications of vector components of a field at a location of the mobile device, the vector components of the field defining the field; and send the first indications of vector components of the field in association with the transformation to a server; or determine second indications of vector components of the field using the first indications of vector components of the field and the transformation, the second indications of vector components of the field being indicative of vector components of the field at the location of the mobile device in the reference coordinate system, and send, to the server, the second indications of vector components of the field; or send, to the server, the first indications of vector components of the field and determine and transmit, to the server, the second indications of vector components of the field.

Implementations of such a mobile device may include on or more of the following features. The first indications of vector components of the field include an indication of each of an x-component, a y-component, and a z-component of the field in the mobile-device coordinate system, and the second indications of vector components of the field include an indication of each of an x-component, a y-component, and a z-component of the field in the reference coordinate system. The processor is configured to obtain the first indications of vector components of the field by receiving measurements of respective magnetic field components from one or more field sensors. The camera is configured to obtain the visible light communication signals by capturing black-and-white images with an exposure duration of less than 100 microseconds. The camera is configured to obtain the visible light communication signals by capturing images with a resolution of no more than 400,000 pixels. The processor is further configured to determine the location of the mobile device using the visible light communication signals. The processor is configured to: determine the second indications of vector components of the field; determine a location of the mobile device corresponding to the second indications of vector components of the field; and produce a fingerprint map using the second indications of vector components of the field and the location of the mobile device.

Another example mobile device includes: means for obtaining visible light communication signals; means for determining an indication of yaw of the mobile device relative to a reference coordinate system using the visible light communication signals; means for obtaining an indication of roll of the mobile device relative to the reference coordinate system; means for obtaining an indication of pitch of the mobile device relative to the reference coordinate system; means for determining a transformation of a mobile-device coordinate system of the mobile device to the reference coordinate system using the indication of roll, the indication of pitch, and the indication of yaw of the mobile device relative to the reference coordinate system; means for measuring first indications of vector components of a field, the vector components of the field defining a vector the field; and means for sending, to a server, the first indications of vector components of the field and the transformation; or means for determining second indications of vector field components of the field using the first indications of vector components of the field and the transformation, the second indications of vector field components of the field being indicative of vector components of the vector field at a location of the mobile device in the reference coordinate system, and for sending, to the server, the second indications of vector components of the field; or means for sending, to the server, the first indications of vector components of the field and the transformation, for determining the second indications of vector components of the field, and for sending, to the server, the second indications of vector components of the field.

Implementations of such a mobile device may include on or more of the following features. The first indications of vector components of the field include an indication of each of an x-component, a y-component, and a z-component of the field in the mobile-device coordinate system, and the second indications of vector components of the field include an indication of each of an x-component, a y-component, and a z-component of the field in the reference coordinate system. The means for measuring the first indications of vector components of the field comprises means for measuring respective magnetic field components. The means for obtaining the indication of roll of the mobile device comprises means for obtaining roll measurements from a gyroscope and an accelerometer and sending the indication of roll to the server, and the means for obtaining the indication of pitch of the mobile device comprises means for obtaining pitch measurements from the gyroscope and the accelerometer of the mobile device and sending the indication of pitch to the server. The means for obtaining the visible light communication signals comprises means for capturing black-and-white images with an exposure duration of less than 100 microseconds. The means for obtaining the visible light communication signals at the mobile device comprises means for capturing images with a resolution of no more than 400,000 pixels. The mobile device further includes means for determining the location of the mobile device using the visible light communication signals.

An example non-transitive, processor-readable storage medium stores processor-readable instructions configured to cause a processor to: obtain visible light communication signals; determine an indication of yaw of a mobile device relative to a reference coordinate system using the visible light communication signals; obtain an indication of roll of the mobile device relative to the reference coordinate system; obtain an indication of pitch of the mobile device relative to the reference coordinate system; determine a transformation of a mobile-device coordinate system of the mobile device to the reference coordinate system using the indication of roll, the indication of pitch, and the indication of yaw of the mobile device relative to the reference coordinate system; obtain first indications of vector components of a field, the vector components of the field defining the field; and send, to a server, the first indications of vector components of the field and the transformation; or determine second indications of vector components of the field using the first indications of vector components of the field and the transformation, the second indications of vector components of the field being indicative of vector components of the field at a location of the mobile device in the reference coordinate system, and send, to the server, the second indications of vector components of the field; or send the first indications of vector components of the field to the server, and determine and send, to the server, the second indications of vector components of the field.

Implementations of such a storage medium may include one or more of the following features. The first indications of vector components of the field include an indication of each of an x-component, a y-component, and a z-component of the field in the mobile-device coordinate system, and the second indications of vector components of the field include an indication of each of an x-component, a y-component, and a z-component of the field in the reference coordinate system. The instructions configured to cause the processor to obtain the first indications of vector components of the field comprise instructions configured to cause one or more field sensors to measure respective magnetic field components. The instructions configured to cause the processor to obtain the visible light communication signals comprise instructions configured to cause a camera to capture black-and-white images with an exposure duration of less than 100 microseconds. The instructions configured to cause the processor to obtain the visible light communication signals comprise instructions configured to cause a camera to capture images with a resolution of no more than 400,000 pixels. The storage medium further includes instructions configured to cause the processor to determine the location of the mobile device using the visible light communication signals.

Another example method of determining data of a fingerprint map includes: determining, at a server, a transformation of a mobile-device coordinate system of a mobile device to a reference coordinate system using roll, pitch, and yaw information of the mobile device relative to the reference coordinate system; obtaining, at the server, first indications of vector components of a field at a location of the mobile device; and determining, at the server, second indications of vector components of the field using the first indications of vector components of the field and the transformation, the second indications of vector components of the field being indicative of vector components of the field at the location of the mobile device in the reference coordinate system.

Implementations of such a method may include one or more of the following features. The method further includes combining the second indications of vector components of the field at the location of the mobile device with other second indications, from other mobile devices, of vector components of the field with a location related to the location of the mobile device to determine aggregate indications of vector components of the field associated with the location of the mobile device. The method further includes combining the aggregate indications of vector components of the field at the location of the mobile device with aggregate indications of vector components of the field at other locations to form a fingerprint map for a venue; and transmitting the fingerprint map for the venue to at least one of at least one mobile device or an entity configured to communicate with mobile devices to provide the fingerprint map to the mobile devices. The first indications of vector components of the field include an indication of each of an x-component, a y-component, and a z-component of the field in the mobile-device coordinate system, and the second indications of vector components of the field include an indication of each of an x-component, a y-component, and a z-component of the field in the reference coordinate system.

An example of a server includes: a memory; and a processor communicatively coupled to the memory and configured to: determine a transformation of a mobile-device coordinate system of a mobile device to a reference coordinate system using roll, pitch, and yaw information of the mobile device relative to the reference coordinate system; obtain first indications of vector components of a field at a location of the mobile device; and determine second indications of vector components of the field using the first indications of vector components of the field and the transformation, the second indications of vector components of the field being indicative of vector components of the field at the location of the mobile device in the reference coordinate system.

Implementations of such a server may include one or more of the following features. The processor is further configured to combine the second indications of vector components of the field at the location of the mobile device with other second indications, from other mobile devices, of vector components of the field with a location related to the location of the mobile device to determine aggregate indications of vector components of the field associated with the location of the mobile device. The processor is further configured to: combine the aggregate indications of vector components of the field at the location of the mobile device with aggregate indications of vector components of the field at other locations to form a fingerprint map for a venue; and transmit the fingerprint map for the venue to at least one of the mobile device, another mobile device, or an entity configured to communicate with mobile devices to provide the fingerprint map to the mobile devices.

Another example of a server includes: first determining means for determining a transformation of a mobile-device coordinate system of a mobile device to a reference coordinate system using roll, pitch, and yaw information of the mobile device relative to the reference coordinate system; means for obtaining first indications of vector components of a field at a location of the mobile device; and second determining means, communicatively coupled to the means for obtaining and the first determining means, for determining second indications of vector components of the field using the first indications of vector components of the field and the transformation, the second indications of vector components of the field being indicative of vector components of the field at the location of the mobile device in the reference coordinate system.

Implementations of such a server may include one or more of the following features. The server further includes means for combining the second indications of vector components of the field at the location of the mobile device with other second indications, from other mobile devices, of vector components of the field with a location related to the location of the mobile device to determine aggregate indications of vector components of the field associated with the location of the mobile device. The server further includes means for combining the aggregate indications of vector components of the field at the location of the mobile device with aggregate indications of vector components of the field at other locations to form a fingerprint map for a venue; and means for transmitting the fingerprint map for the venue to at least one of at least one mobile device or an entity configured to communicate with mobile devices to provide the fingerprint map to the mobile devices. The first indications of vector components of the field include an indication of each of an x-component, a y-component, and a z-component of the field in the mobile-device coordinate system, and the second indications of vector components of the field include an indication of each of an x-component, a y-component, and a z-component of the field in the reference coordinate system.

Another example of a non-transitive, processor-readable storage medium includes processor-readable instructions configured to cause a processor to: determine a transformation of a mobile-device coordinate system of a mobile device to a reference coordinate system using roll, pitch, and yaw information of the mobile device relative to the reference coordinate system; obtain first indications of vector components of a field at a location of the mobile device; and determine second indications of vector components of the field using the first indications of vector components of the field and the transformation, the second indications of vector components of the field being indicative of vector components of the field at the location of the mobile device in the reference coordinate system.

Implementations of such a storage medium may include one or more of the following features. The storage medium further includes instructions configured to cause the processor to combine the second indications of vector components of the field at the location of the mobile device with other second indications, from other mobile devices, of vector components of the field with a location related to the location of the mobile device to determine aggregate indications of vector components of the field associated with the location of the mobile device. The storage medium further includes instructions configured to cause the processor to: combine the aggregate indications of vector components of the field at the location of the mobile device with aggregate indications of vector components of the field at other locations to form a fingerprint map for a venue; and transmit the fingerprint map for the venue to at least one of at least one mobile device or an entity configured to communicate with mobile devices to provide the fingerprint map to the mobile devices. The first indications of vector components of the field include an indication of each of an x-component, a y-component, and a z-component of the field in the mobile-device coordinate system, and the second indications of vector components of the field include an indication of each of an x-component, a y-component, and a z-component of the field in the reference coordinate system.

### BRIEF DESCRIPTION OF THE DRAWINGS

FIG. 1 is a diagram illustrating a top view of an indoor venue including a mobile device.

FIG. 2A is a diagram illustrating a mobile device.

FIG. 2B is a diagram illustrating a map of an indoor venue.

FIG. 3 is a flowchart of a method for a mobile device.

FIG. 4 is a flowchart of a method for a mobile device.

FIG. 5 is a conceptual data flow diagram illustrating the data flow between different modules/means/components in an exemplary apparatus.

FIG. 6 is a diagram illustrating an example of a hardware implementation for an apparatus employing a processing system.

FIG. 7 is a simplified diagram of a communication system.

FIG. 8 is a block diagram of components of an example of the mobile device shown in FIG. 7.

FIG. 9 is a functional block diagram of components of an example of the mobile device shown in FIG. 8.

FIG. 10 is a block diagram of components of an example of a server shown in FIG. 7

FIG. 11 is a functional block diagram of components of an example of the server shown in FIG. 10.

FIG. 12 is a block flow diagram of a process of determining data of a fingerprint map.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several embodiments of a mobile device will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, firmware, middleware, microcode, hardware description language, or the like shall be construed broadly to mean instructions, instruction sets, code, code segments, program code, programs, subprograms, software modules, applications, software applications, software packages, routines, subroutines, objects, executables, threads of execution, procedures, functions, etc.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually store data magnetically, while data may be read from discs optically with lasers. Combinations of the above should also be included within the scope of computer-readable media.

As used herein, the term mobile device may refer to a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. Moreover, the term mobile device may also be referred to by those skilled in the art as a mobile station, a subscriber station, a mobile unit, a subscriber unit, a wireless unit, a remote unit, a wireless device, a remote device, a mobile subscriber station, an access terminal, a mobile terminal, a wireless terminal, a remote terminal, a handset, a user agent, a user equipment, a mobile client, a client, or some other suitable terminology.

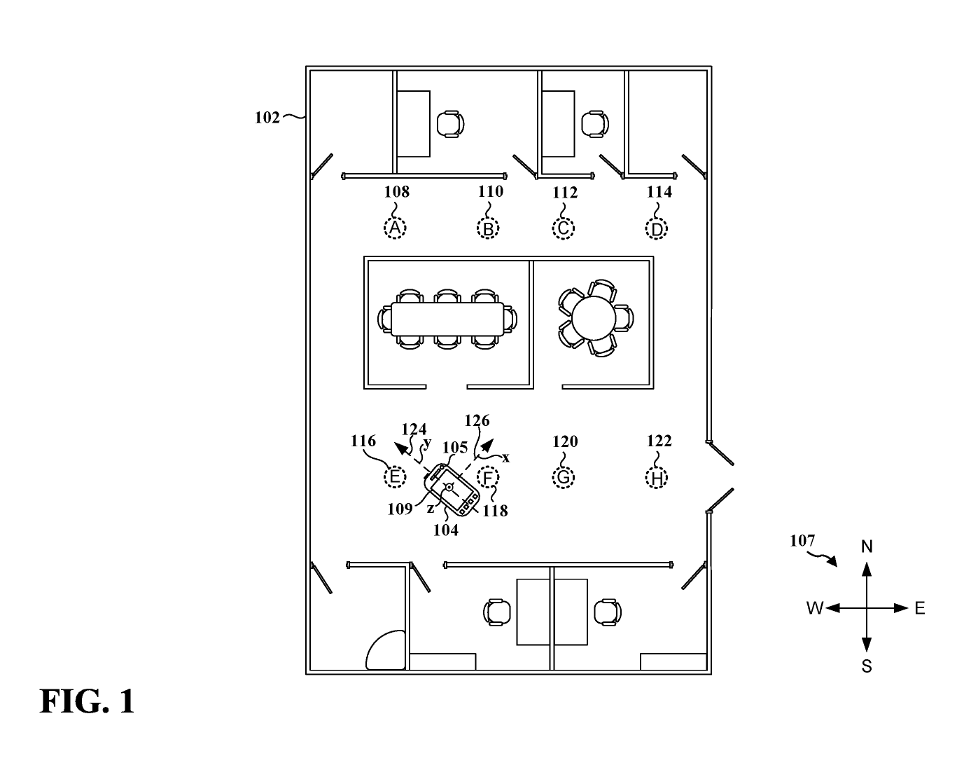

FIG. 1 is a diagram illustrating a top view of an indoor venue including a mobile device 104. In the configuration of FIG. 1, the indoor venue is a floor 102 of an office building. For example, the mobile device 104 may be held by a user (not shown) who is stationary or moving on the floor 102. In the configuration of FIG. 1, the mobile device 104 is oriented toward a north-west direction with respect to reference axes 107 of the floor 102. For example, as shown in FIG. 1, an orientation axis 124 (e.g., the direction toward which the mobile device 104 is pointed) is oriented toward the north-west direction with respect to the reference axes 107. The orientation axis 124 corresponds to a y-axis of a mobile-device coordinate system, with the y-axis extending along a length of the mobile device 104. An x-axis 126 of the mobile-device coordinate system extends perpendicular to the y-axis and extends along a width of the mobile device 104. Consequently, a z-axis of the mobile-device coordinate system extends perpendicular to both the x-axis and the y-axis and extends along a thickness of the mobile device 104, i.e., perpendicular to a surface of a display 109 of the mobile device 104 (here, the positive portion of the z-axis extending out of the page toward a viewer of FIG. 1).

In an embodiment, floor 102 may include two or more orientation indicators (also referred to as “indicators” or “luminaires”) located above the mobile device 104. The indicators are indirect indicators of orientation in that by observing two or more orientation indicators from the mobile device 104, the orientation of the mobile device 104 may be determined. In the configuration of FIG. 1, floor 102 includes indicators 108, 110, 112, 114, 116, 118, 120, and 122. It should be understood that floor 102 may include a lesser or greater number of indicators than those indicated in FIG. 1. In an embodiment, each of the indicators may be a light fixture or a luminaire and may be configured to communicate information for identifying a corresponding indicator. For example, such light fixture or luminaire may include a light emitting diode (LED) as the light producing element. In another example, each of the indicators may be a visual indicator, such as a QR Code® (also referred to as a quick response code) or a color panel, or may include a unique visual characteristic, such as a distinct shape (e.g., a square shape, a triangular shape, a star shape, etc.). In at least some configurations, the indicators may each be installed on a ceiling of the floor 102, such that the indicators are visible from the ground of the floor 102. As described infra, the mobile device 104 may be configured to use two or more of the indicators to determine the orientation axis 124 of the mobile device 104 with respect to the reference axes 107.

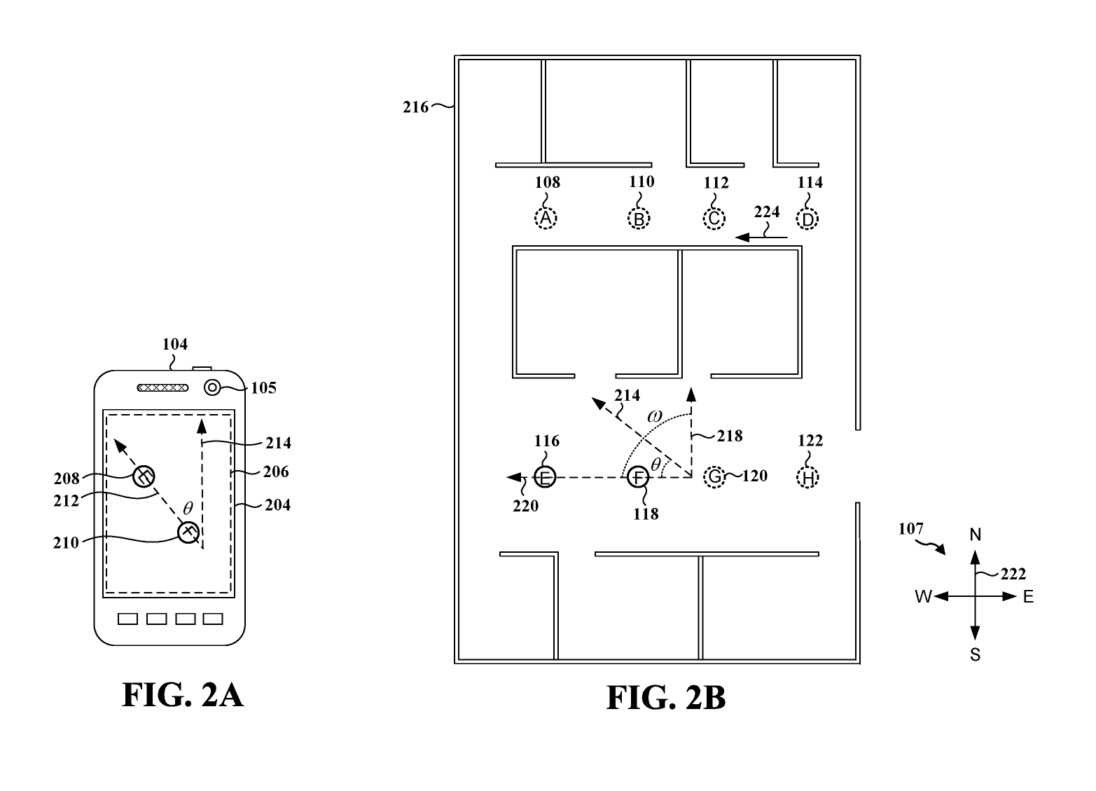

FIG. 2A is a diagram illustrating the mobile device 104. As shown in FIG. 2A, the mobile device 104 includes a front facing camera 105 and a display screen 204. In an embodiment, the front facing camera 105 may capture images via a digital image sensor (e.g., a CMOS sensor) installed in the front facing camera 105. The mobile device 104 may display images captured by the front facing camera 105 on the display screen 204.

With reference to FIG. 1, the mobile device 104 may operate the front facing camera 105 to capture one or more images of two or more indicators (e.g., indicators 108, 110, 112, 114, 116, 118, 120, and 122). The mobile device 104 may further operate the front facing camera 105 to receive identifying information from two or more of the indicators (e.g., indicators 108, 110, 112, 114, 116, 118, 120, and 122) located above the mobile device 104 and within a field of view of the front facing camera 105. In at least some embodiments, and as discussed infra, the front facing camera 105 may determine identifying information from one or more of the indicators in FIG. 1 without receiving any identifying information from the one or more indicators.

In an embodiment, the indicators (e.g., indicators 108, 110, 112, 114, 116, 118, 120, and 122) may be LED devices configured to transmit visible light communication (VLC) signals. The VLC signals may intentionally convey information, e.g., by being modulated (e.g., pulse-width modulated, amplitude modulated, frequency modulated) using information to be conveyed. The VLC signals may be detected by the front facing camera 105 and the digital image sensor of the mobile device 104. The VLC signals may then be decoded by the mobile device 104. In such embodiment, the VLC signals transmitted by an indicator may contain identification information of the indicator. The mobile device 104 may associate the indicator with the identification information transmitted by the indicator. For example, the identification information transmitted by an indicator may be a 48 bit MAC address that is unique with respect to other indicators. Other types of identification information may be transmitted by the indicators if such identification information is unique and allows for disambiguation of an indicator located in a particular venue (e.g., a floor of an office building, supermarket, or shopping mall). In an embodiment, the mobile device 104 may be configured to simultaneously decode VLC signals from multiple indicators.

For example, the front facing camera 105 may detect and decode first VLC signals transmitted by indicator E 116 and second VLC signals transmitted by indicator F 118. The mobile device 104 may decode the first VLC signals transmitted by indicator E 116 in order to determine the identifying information included in the first VLC signals and to identify the indicator E 116. The mobile device 104 may decode the second VLC signals transmitted by indicator F 118 in order to determine the identifying information included in the second VLC signals and to identify the indicator F 118. In this example, the mobile device 104 may identify the indicator E 116 based on a first 48 bit MAC address received from the indicator E 116 via the first VLC signals, where the first 48 bit MAC address identifies or corresponds to the indicator E 116. The mobile device 104 may identify the indicator F 118 based on a second 48 bit MAC address received from the indicator F 118 via the second VLC signals, where the second 48 bit MAC address identifies or corresponds to the indicator F 118.

One or more of the indicators (e.g., indicators 108, 110, 112, 114, 116, 118, 120, and 122) may not transmit any information. For example, the signals from one or more of the indicators may not be configured using any particular information, e.g., not being modulated using such information. In such embodiment, information may be embedded (i.e., inherent) in the shape, color, and or visual structure of the indicator which may be detected and interpreted by the digital image sensor (e.g., a CMOS sensor) installed in the front facing camera 105.

In an embodiment, after the mobile device 104 has identified two or more indicators, the mobile device 104 may reference a map of the venue in which the mobile device 104 is currently located. In at least some configurations, the map of the venue may include the locations of two or more of the indicators (e.g., indicators 108, 110, 112, 114, 116, 118, 120, and 122) located at the venue.

In an embodiment, the map 216 may be stored in a memory of the mobile device 104. In another embodiment, the map 216 may be stored on a remote server (not shown). In such embodiment, the mobile device 104 may query the remote server for orientation information. For example, the mobile device 104 may send information regarding the identified indicators 116 and 118 to the remote server (also referred to as a network) along with the query. In at least some configurations, the remote server may respond with the orientation of the mobile device 104. In an embodiment, the map 216 may be downloaded to the mobile device 104 using an out-of-band (RF) signal from a wireless local area network (WLAN), a wide area network (WAN), or other network. For example, such downloading of the map 216 may be triggered automatically by the mobile device 104 when mobile device 104 determines that it has entered an indoor venue. For example, the mobile device 104 may determine that it has entered an indoor venue using contextual information or by employing a positioning system that uses a combination of GPS and terrestrial RF technologies.

For example, with reference to FIG. 2B, the mobile device 104 may reference a map 216 of the floor 102. In such example, the mobile device 104 may determine the locations of the identified indicators (e.g., indicator E 116 and indicator F 118) on the map 216 and may determine the orientation of the identified indicators with respect to the reference axes 107. The mobile device 104 may then determine its own orientation axis 124 with respect to the reference axes 107.

An example orientation determination operation of the mobile device 104 will now be described with reference to FIGS. 1, 2A and 2B. As previously described with respect to FIG. 1, the mobile device 104 may capture one or more images of the indicators 116 and 118 via the front facing camera 105, such as the image 206 shown in FIG. 2A. The mobile device 104 identifies the indicators 116 and 118, e.g., by analyzing the received light for embedded identifiers and/or by comparing signatures of the received light against a mapping of signatures and indicator identities. In an embodiment, the mobile device 104 may receive identifying information from each the indicators 116 and 118 via the front facing camera 105 and may identify the indicators 116 and 118 based on the received identifying information. It should be noted that the mobile device 104 captures the image 206 of the indicators 116 and 118 while oriented according to the orientation axis (e.g., orientation axis 124) to be determined by the mobile device 104. The mobile device 104, having identified the indicators 116, 118, identifies the locations of indicators 116 and 118 in the captured image 206 on the map 216. The map 216 may be stored in a memory of the mobile device 104 or received from a remote server.

As shown in FIG. 2B, the mobile device 104 may draw a vector 220 on the map 216 connecting the identified indicators 116 and 118. In an embodiment, the vector 220 may be drawn to pass through the center of indicator E 116 and the center of indicator F 118 as shown in FIG. 2B. The vector 220 may be referred to as the indicator axis. The mobile device 104 may determine the angle of the indicator axis (e.g., vector 220) relative to a reference axis, such as the north axis 222 of the reference axes 107. For ease of description, the north axis 222 is shown in FIG. 2B as vector 218. The angle ω of the indicator axis (e.g., vector 220) relative to the reference axis (e.g., vector 218) represents the orientation of the indicator axis (e.g., vector 220).

The mobile device 104 may draw a vector 212 on the image 206 captured by the front facing camera 105. In an embodiment, the vector 212 may be drawn to pass through the center of the set of pixels identified as indicator E 208 and the center of the set of pixels identified as indicator F 210 as shown in FIG. 2A. The vector 212 may be referred to as the image indicator axis. The mobile device 104 may determine the angle of the image indicator axis (e.g., vector 212) relative to a fixed axis (also referred to as a screen axis) (e.g., vector 214), which is an axis extending from the bottom of the screen 204 to the top of the screen 204 parallel to the orientation axis 124 (see FIGS. 1, 2B). The angle θ of the image indicator axis (e.g., vector 212) relative to the screen axis (e.g., vector 214) represents the orientation of the image indicator axis (e.g., vector 212) relative to the screen axis (e.g., vector 214). The negative of the angle θ represents the angle of the orientation axis 124 (e.g., vector 124) of the mobile device 104 relative to the indicator axis (e.g., vector 220). Therefore, the orientation axis 124 or the screen axis 214 of the mobile device 104 relative to the reference axis (e.g., the north axis 222 represented as vector 218 in FIG. 2B) may be determined by summing the angle ω and the angle −θ. For example, with reference to FIG. 2B, the mobile device 104 may determine the sum of the angle ω and the angle −θ, where the sum represents the angle of the orientation axis 124 or the screen axis 214 of the mobile device 104 with respect to the reference axis (e.g., vector 218).

In the previously described embodiment where the mobile device 104 queries the remote server for orientation information, the mobile device 104 may transmit a query that includes the identities of the indicators 116 and 118 and one or more of the captured images of the indicators 116 and 118 to the remote server. The remote server may then determine the orientation of the mobile device 104 using the identities of the indicators 116 and 118 and the one or more captured images of the indicators 116 and 118. The remote server may then transmit information regarding the orientation of the mobile device 104. The mobile device 104 may receive the information regarding the orientation of the mobile device 104 and may determine its orientation using the received information. For example, the information regarding the orientation of the mobile device 104 received from the remote server may indicate the orientation of the mobile device 104 with respect to a reference axis (e.g., the north axis 222 represented as vector 218 in FIG. 2B). For example, with reference to FIG. 2B, the orientation of the mobile device 104 with respect to the reference axis may be represented as the sum of angle ω and the angle −θ.

It should be understood that the reference axis may be selected to be an axis different from the north axis 222. In an embodiment, the reference axis may be any fixed reference axis, such as a magnetic/geographic north axis or south axis, where the reference axis is stored in the map. In another embodiment, the reference axis may be determined relative to a reference axis contained in the map. For example, the reference axis may be an axis corresponding to a hallway 224 on the map 216. As another example, the reference axis may be a particular aisle in a supermarket.

It should also be understood that the disclosure herein may be applied to a configuration where one or more of the indicators (e.g., indicators 108, 110, 112, 114, 116, 118, 120, and 122) are installed on the ground of the floor 102 (i.e., below the mobile device 104), or elsewhere (e.g., along one or more walls) in the venue, and/or where the mobile device 104 uses a rear camera (not shown) in addition to or instead of the front facing camera 105 to receive information for identifying two or more of the indicators and for capturing the one or more images of the indicators.

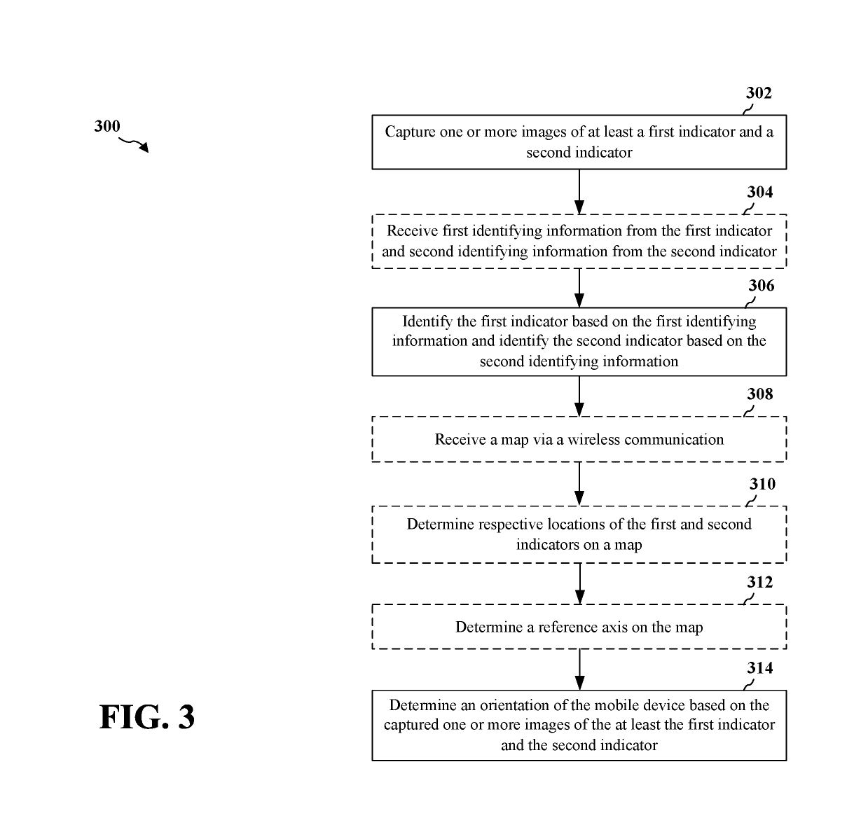

FIG. 3 is a flow chart 300 of a method for determining an orientation of a mobile device. For example, the method may be performed by the mobile device 104. Alternatively, one or more portions of the method 300 may be performed outside of the mobile device 104, e.g., at a server with which the mobile device 104 communicates, e.g., through a cellular network and/or other form of communication network.

At step 302, the mobile device captures one or more images of at least a first indicator and a second indicator. For example, with reference to FIG. 1, the mobile device 104 may operate the front facing camera 105 to capture one or more images of two or more indicators (e.g., indicator E 116 and indicator F 118).

At step 304, the mobile device receives first identifying information from the first indicator and receives second identifying information from the second indicator. In an embodiment, the first and second indicators may be LEDs configured to communicate the identifying information. For example, with reference to FIG. 1, the mobile device 104 may operate the front facing camera 105 to receive identifying information from each of two or more of the indicators (e.g., indicators 108, 110, 112, 114, 116, 118, 120, and 122) located above the mobile device 104 and within a field of view of the front facing camera 105. In an embodiment, each indicator may be an LED device configured to transmit a VLC signal that contains identification information of the indicator. For example, the identification information transmitted by an indicator may be a 48 bit MAC address that is unique with respect to other indicators.

At step 306, the mobile device identifies the first indicator based on the first identifying information and identifies the second indicator based on the second identifying information. In one example, with reference to FIG. 1, the mobile device 104 may identify the indicator E 116 based on a first 48 bit MAC address received from the indicator E 116, where the first 48 bit MAC address identifies or corresponds to the indicator E 116. In such example, the mobile device 104 may further identify the indicator F 118 based on a second 48 bit MAC address received from the indicator F 118, where the second 48 bit MAC address identifies or corresponds to the indicator F 118. In another example, with reference to FIG. 1, the mobile device 104 may identify the indicator E 116 based on first identifying information of the indicator E 116 that may be detected by the digital image sensor (e.g., a CMOS sensor) of the front facing camera 105. For example, the first identifying information may be a unique QR Code®, a color panel, or a unique visual characteristic, such as a distinct shape. In such example, the mobile device 104 may identify the indicator F 118 based on second identifying information of the indicator F 118 that may be detected by the digital image sensor (e.g., a CMOS sensor) of the front facing camera 105. For example, the second identifying information may be a unique QR Code®, a color panel, or a unique visual characteristic, such as a distinct shape.

At step 308, the mobile device receives the map via a wireless communication. In an embodiment, the map is automatically received when the mobile device is located indoors, e.g., in response to entering a venue, in response to turning on inside a venue, etc. For example, with reference to FIG. 2B, the mobile device 104 may receive a map 216 of the indoor venue (e.g., floor 102) shown in FIG. 1. In an embodiment, and as shown in FIG. 2B, the map 216 may indicate the locations of the indicators (e.g., indicators 108, 110, 112, 114, 116, 118, 120, and 122) located in the indoor venue.

At step 310, the mobile device determines respective locations of the first and second indicators on a map. For example, with reference to FIG. 2B, the mobile device 104 may determine the locations of indicator E 116 and indicator F 118 on the map 216. For example, knowing the identities of the indicators 116, 118 from the first and second identifying information, the mobile device 104 searches the map for the indicators 116, 118. Further in this example, in response to the mobile device 104 finding the indicators 116, 118 on the map 216, the mobile device 104 obtains location information provided by the map 216 that corresponds to the indicators 116, 118.

At step 312, the mobile device determines a reference axis on the map. For example, with reference to FIG. 2B, the mobile device 104 may determine the north axis 222 of the reference axes 107 as the reference axis. In an embodiment, the reference axis may be indicated in the map 216.

At step 314, the mobile device determines an orientation of the mobile device based on the captured one or more images of the at least the first indicator and the second indicator. In an embodiment, the orientation of the mobile device is determined relative to the reference axis. For example, as shown in FIG. 2B, the mobile device 104 may draw the indicator axis (e.g., vector 220) on the map 216 connecting the identified indicators 116 and 118. The mobile device 104 may determine the angle of the indicator axis (e.g., vector 220) relative to a reference axis (e.g., vector 218). The angle ω of the indicator axis (e.g., vector 220) relative to the reference axis (e.g., vector 218) represents the orientation of the indicator axis (e.g., vector 220).

The mobile device 104 may draw the image indicator axis (e.g., vector 212) on the image 206 captured by the front facing camera 105. The mobile device 104 may determine the angle of the image indicator axis (e.g., vector 212) relative to the screen axis (e.g., vector 214), which is defined as the axis extending from the bottom of the screen 204 to the top of the screen 204. The angle θ of the image indicator axis (e.g., vector 212) relative to the screen axis (e.g., vector 214) represents the orientation of the image indicator axis (e.g., vector 212) relative to the screen axis (e.g., vector 214). The negative of the angle θ represents the orientation axis 124 of the mobile device 104 relative to the indicator axis (e.g., vector 220). Therefore, the orientation axis 124 of the mobile device 104 relative to the reference axis (e.g., the north axis 222 represented as vector 218 in FIG. 2B) may be determined by summing the angle ω and the angle −θ. For example, with reference to FIG. 2B, the mobile device 104 may determine the sum of the angle ω and the angle −θ, where the sum represents the angle of the orientation axis 124 or the screen axis 214 of the mobile device 104 with respect to the reference axis (e.g., vector 218).

It should be understood that the steps 304, 308, 310, and 312 indicated with dotted lines in FIG. 3 represent optional steps. For example, in at least some embodiments, steps 302, 306, and 314 may be performed without performing steps 304, 308, 310, and 312. It should be further understood that various combinations of the steps 304, 308, 310, and 312 may be performed in accordance with various embodiments. For example, in at least some embodiments, steps 302, 304, 306, and 314 may be performed without performing steps 308, 310, and 312.

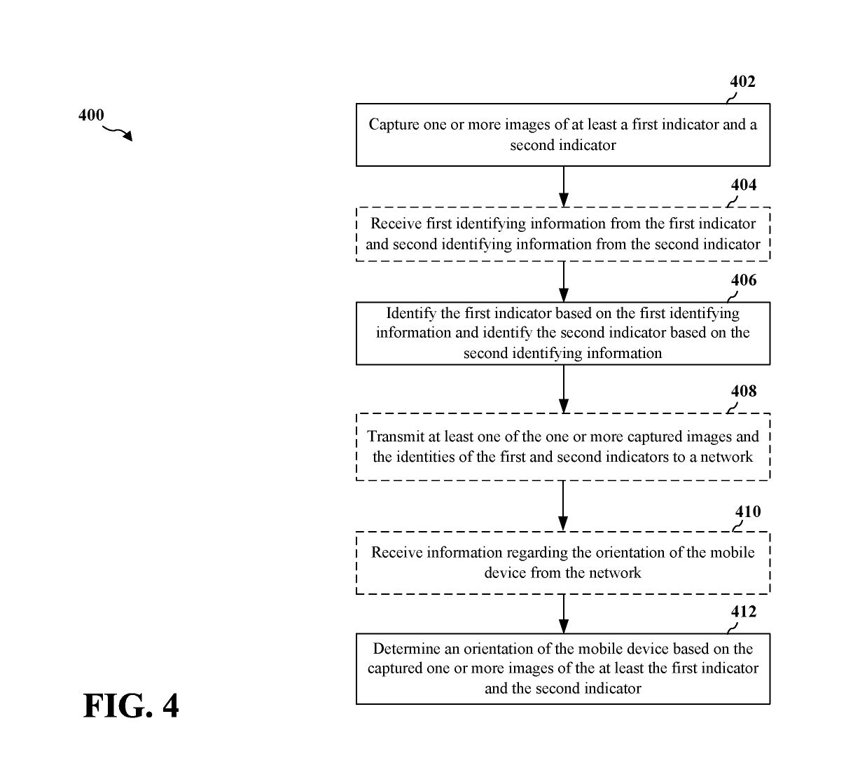

FIG. 4 is a flow chart 400 of a method for determining orientation of a mobile device. For example, the method may be performed by the mobile device 104. Alternatively, one or more portions of the method 300 may be performed outside of the mobile device 104, e.g., at a server with which the mobile device 104 communicates, e.g., through a cellular network and/or other form of communication network.

At step 402, the mobile device captures one or more images of at least the first indicator and the second indicator. For example, with reference to FIG. 1, the mobile device 104 may operate the front facing camera 105 to capture one or more images of two or more indicators (e.g., indicator E 116 and indicator F 118).

At step 404, the mobile device receives first identifying information from the first indicator and receives second identifying information from the second indicator. In an embodiment, each of the first and second indicators may be an LED configured to communicate the identifying information. For example, with reference to FIG. 1, the mobile device 104 may operate the front facing camera 105 to receive identifying information from two or more of the indicators (e.g., indicators 108, 110, 112, 114, 116, 118, 120, and 122) located above the mobile device 104 and within a field of view of the front facing camera 105. In an embodiment, each indicator may be an LED device configured to transmit a VLC signal that contains identification information of the indicator. For example, the identification information transmitted by an indicator may be a 48 bit MAC address that is unique with respect to other indicators.

At step 406, the mobile device identifies the first indicator based on the first identifying information and identifies the second indicator based on the second identifying information. In one example, with reference to FIG. 1, the mobile device 104 may identify the indicator E 116 based on a first 48 bit MAC address received from the indicator E 116, where the first 48 bit MAC address identifies or corresponds to the indicator E 116. In such example, the mobile device 104 may identify the indicator F 118 based on a second 48 bit MAC address received from the indicator F 118, where the second 48 bit MAC address identifies or corresponds to the indicator F 118. In another example, with reference to FIG. 1, the mobile device 104 may identify the indicator E 116 based on first identifying information of the indicator E 116 that may be detected by the digital image sensor (e.g., a CMOS sensor) of the front facing camera 105. For example, the first identifying information may be a unique QR Code®, a color panel, or a unique visual characteristic, such as a distinct shape. In such example, the mobile device 104 may identify the indicator F 118 based on second identifying information of the indicator F 118 that may be detected by the digital image sensor (e.g., a CMOS sensor) of the front facing camera 105. For example, the second identifying information may be a unique QR Code®, a color panel, or a unique visual characteristic, such as a distinct shape.

At step 408, the mobile device transmits at least one of the one or more captured images and the identities of the first and second indicators to a network.

At step 410, the mobile device receives information regarding the orientation of the mobile device from the network.

At step 412, the mobile device determines an orientation of the mobile device based on the captured one or more images of the at least the first indicator and the second indicator. In an embodiment, determination of the orientation of the mobile device is further based on the received information regarding the orientation of the mobile device. For example, the information regarding the orientation of the mobile device received from the network may indicate the orientation of the mobile device 104 with respect to a reference axis (e.g., the north axis 222 represented as vector 218 in FIG. 2B). For example, with reference to FIG. 2B, the orientation of the mobile device 104 with respect to a reference axis may be represented as the sum of angle ω and the angle −θ.

It should be understood that the steps 404, 408, and 410 indicated with dotted lines in FIG. 4 represent optional steps. For example, in at least some embodiments, steps 402, 406, and 412 may be performed without performing steps 404, 408, and 410. It should be further understood that various combinations of the steps 404, 408, and 410 may be performed in accordance with various embodiments. For example, in at least some embodiments, steps 402, 404, 406, and 412 may be performed without performing steps 408 and 410.

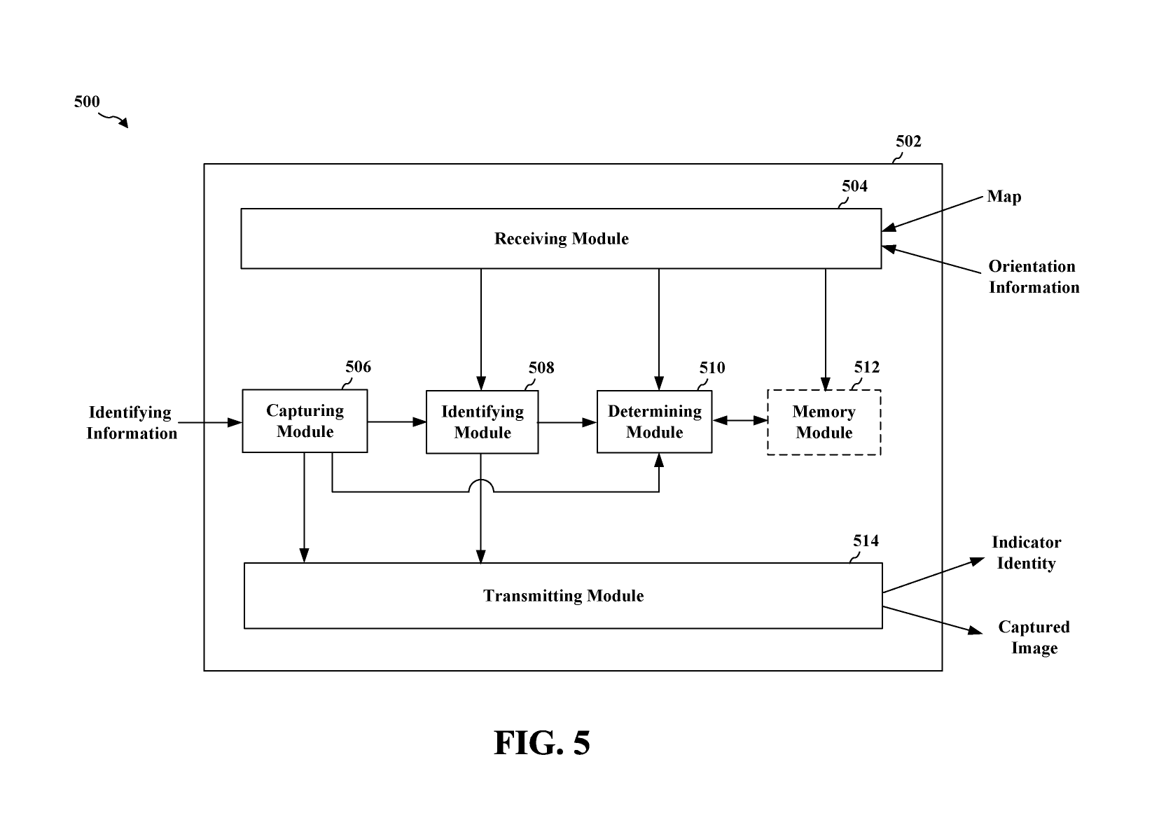

FIG. 5 is a conceptual data flow diagram 500 illustrating the data flow between different modules/means/components in an exemplary apparatus 502. The apparatus 502 may be a mobile device, such as the mobile device 104. The apparatus 502 includes a receiving module 504 that receives information regarding the orientation of the apparatus from the network and that receives a map via a wireless communication, a capturing module 506 that receives first identifying information from a first indicator and second identifying information from a second indicator, and that captures one or more images of at least the first indicator and the second indicator, an identifying module 508 that identifies the first indicator based on the first identifying information and the second indicator based on the second identifying information, a determining module 510 that determines an orientation of the apparatus based on the captured one or more images of the at least the first indicator and the second indicator, determines respective locations of the first and second indicators on a map, and determines a reference axis on the map, a memory module 512 that stores a map, and a transmitting module 514 that transmits at least one of the one or more captured images and the identities of the first and second indicators to a network.

The apparatus may include additional modules that perform each of the steps of the algorithms in the aforementioned flow charts of FIGS. 3 and 4. As such, each step in the aforementioned flow charts of FIGS. 3 and 4 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

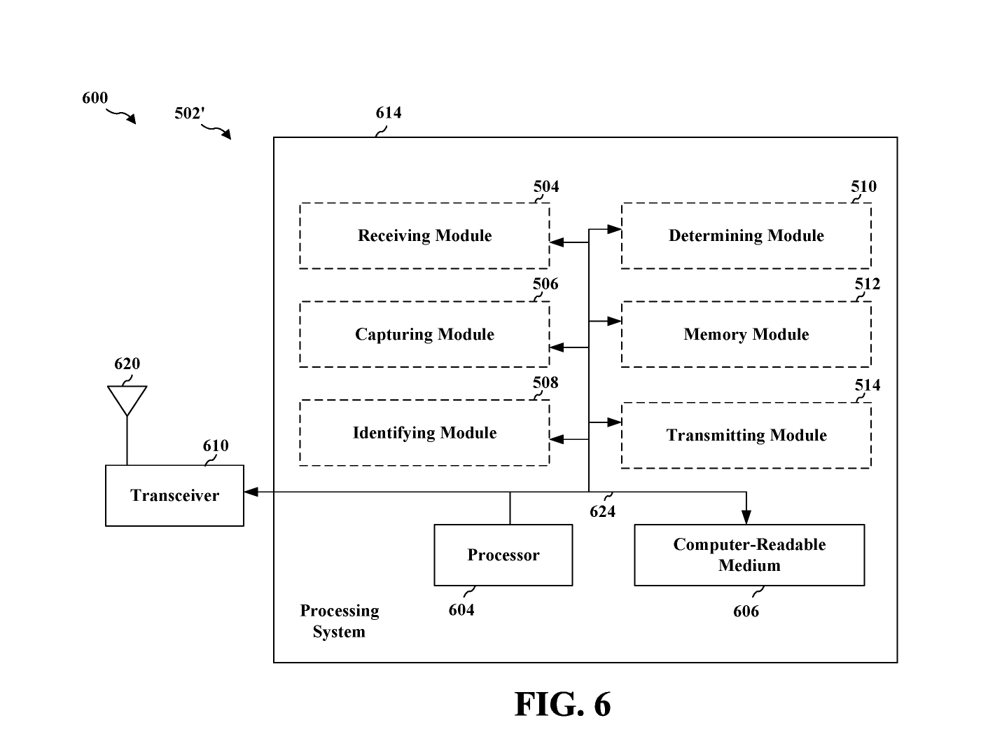

FIG. 6 is a diagram 600 illustrating an example of a hardware implementation for an apparatus 502′ employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 604, the modules 504, 506, 508, 510, 512, and 514, and the computer-readable medium 606. The bus 624 may also link various other circuits such as timing sources, peripherals, voltage regulators, and power management circuits, which are well known in the art, and therefore, will not be described any further.

The processing system 614 may be coupled to a transceiver 610. The transceiver 610 is coupled to one or more antennas 620. The transceiver 610 provides a means for communicating with various other apparatus over a transmission medium. The transceiver 610 receives a signal from the one or more antennas 620, extracts information from the received signal, and provides the extracted information to the processing system 614, specifically the receiving module 504. In addition, the transceiver 610 receives information from the processing system 614, specifically the transmission module 514, and based on the received information, generates a signal to be applied to the one or more antennas 620. The processing system 614 includes a processor 604 coupled to a computer-readable medium 606. The processor 604 is responsible for general processing, including the execution of software stored on the computer-readable medium 606. The software, when executed by the processor 604, causes the processing system 614 to perform the various functions described supra for any particular apparatus. The computer-readable medium 606 may also be used for storing data that is manipulated by the processor 604 when executing software. The processing system further includes at least one of the modules 504, 506, 508, 510, 512, and 514. The modules may be software modules running in the processor 604, resident/stored in the computer readable medium 606, one or more hardware modules coupled to the processor 604, or some combination thereof.

In at least some configurations, the apparatus 502/502′ for wireless communication includes means for capturing one or more images of at least a first indicator and a second indicator, means for identifying the first indicator based on first identifying information and identifying the second indicator based on second identifying information, means for determining an orientation of the apparatus based on the captured one or more images of the at least a first indicator and a second indicator, means for receiving the first identifying information from the first indicator and the second identifying information from the second indicator, means for determining respective locations of the first and second indicators on a map, means for determining a reference axis on the map, means for transmitting at least one of the one or more captured images and the identities of the first and second indicators to a network, means for receiving information regarding the orientation of the apparatus from the network, and means for receiving the map via a wireless communication. The aforementioned means may be one or more of the aforementioned modules of the apparatus 502 and/or the processing system 614 of the apparatus 502′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

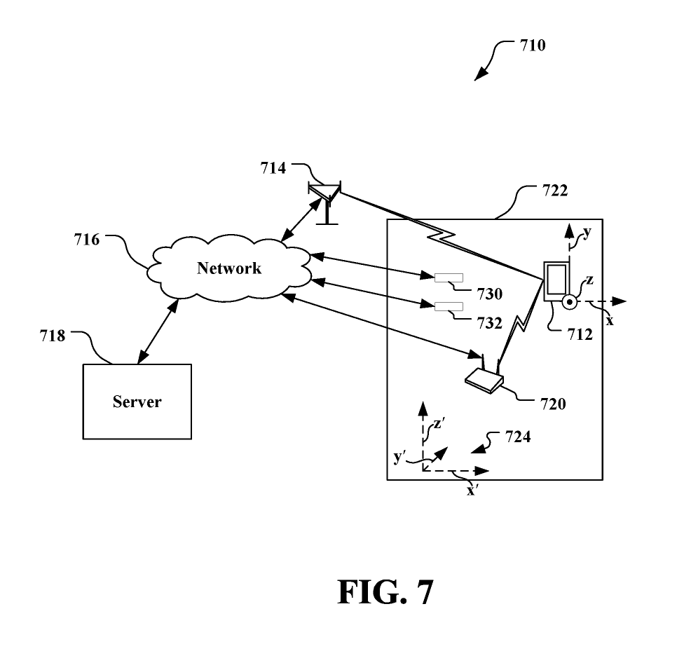

Referring to FIG. 7, a communication system 710 includes a mobile device 712, a base transceiver station (BTS) 714, a network 716, a server 718, an access point (AP) 720, and indicators, here lights 730, 732 disposed in a building 722. The system 710 is a communication system in that the system 710 can at least send and receive communications. Although only one mobile device 712, one BTS 714, one network 716, one server 718, and one AP 720 are shown for simplicity, more than one of any of these entities, or any combination of these entities, may be used. Also for simplicity, only the single mobile device 712 is discussed below. As shown, the mobile device 712 is a smartphone, although other types of mobile devices (e.g., personal digital assistants (PDAs), netbooks, notebook computers, tablet computers), either presently known or developed in the future, may be used. The lights 730, 732 may be connected to the network 716, as shown, such that the outputs of the lights 730, 732 may be controlled.

The BTS 714 and/or the AP 720 can wirelessly communicate with the mobile device 712 via antennas. The BTS 714 may also be referred to as an access node (AN), a Node B, an evolved Node B or eNodeB (eNB), etc. The BTS 714 is configured to communicate wirelessly with the mobile device 712 under the control of the server 718 (via the network 716). The BTS 714 and the AP 720 are preferably connected to and communicate with the network 716 through wired connections, although the BTS 714 and/or the AP 720 may also or alternatively communicate wirelessly with the network 716.

The server 718 preferably can communicate with the mobile device 712 via the BTS 714 and/or the AP 720. The server 718 is configured to communicate with multiple mobile devices, aggregate information, e.g., sensed field values in a reference coordinate system, from the mobile devices to produce a fingerprint map as discussed below, and to provide the fingerprint map to mobile devices. Preferably, the fingerprint map is a vector field fingerprint map with three-dimensional vector fields at various locations in the map, e.g., each grid of a gridded map, e.g., of a floor of a venue.

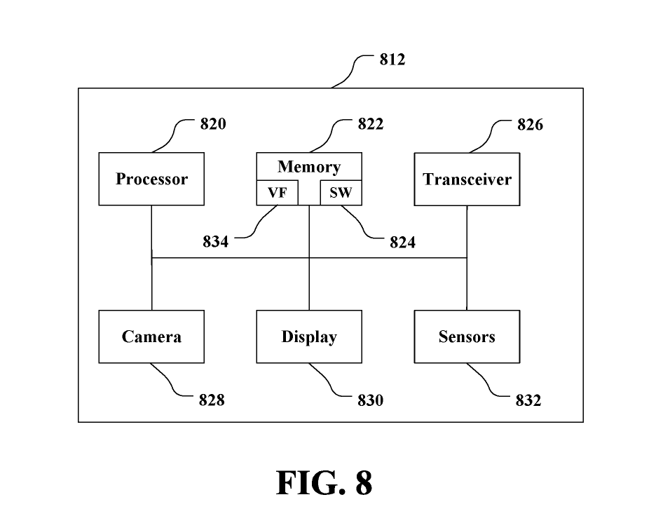

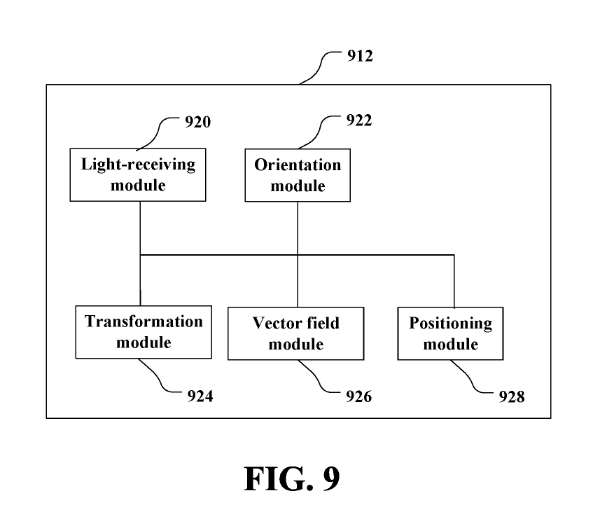

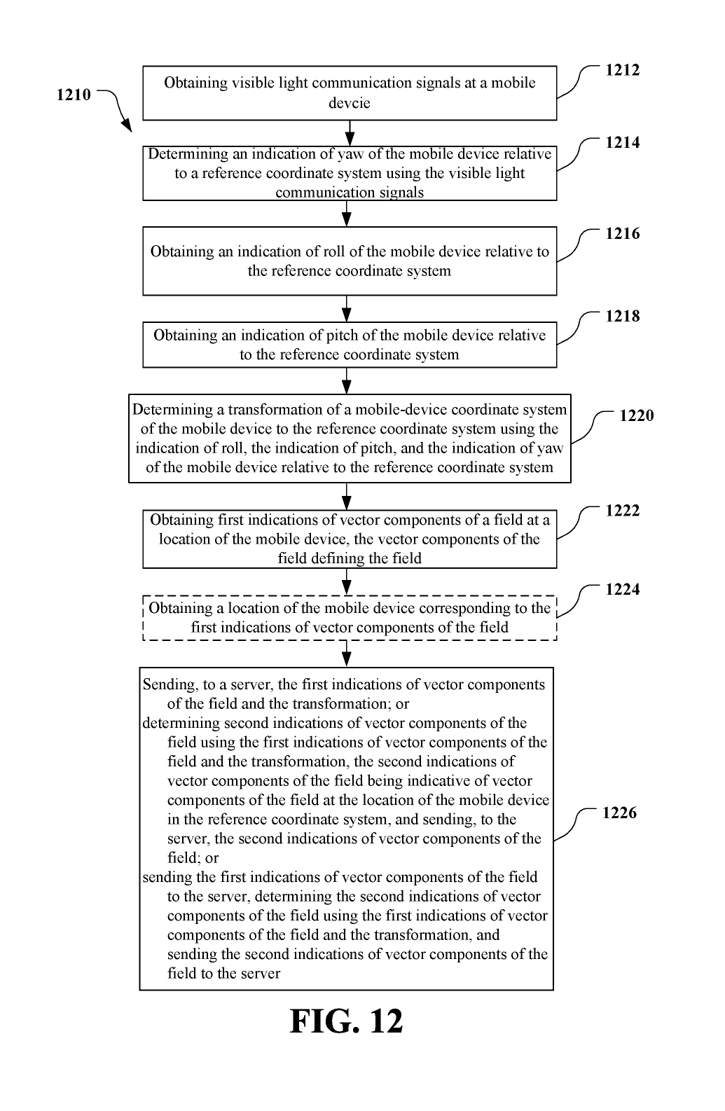

Referring also to FIG. 8, a mobile device 812 comprises a computer system including a processor 820, a memory 822 including software 824, a transceiver 826, a camera 828, a display 830, and sensors 832. The mobile device 812 is an example of the mobile device 712 shown in FIG. 7. The transceiver 826 is configured to communicate bi-directionally with the BTS 714 and the AP 720. The processor 820 is preferably an intelligent hardware device, e.g., a central processing unit (CPU) such as those made or designed by QUALCOMM®, ARM®, Intel® Corporation, or AMD®, a microcontroller, an application specific integrated circuit (ASIC), etc. The processor 820 could comprise multiple separate physical entities that can be distributed in the mobile device 812. The memory 822 includes random access memory (RAM) and read-only memory (ROM). The memory 822 stores the software 824 which is computer-readable, computer-executable software code containing instructions that are configured to, when performed, cause the processor 820 to perform various functions described herein, e.g., as discussed with respect to FIGS. 9 and 12. The software 824 may not be directly executable by the processor 820 but configured to cause the processor 820, e.g., when compiled and executed, to perform the functions. Whether needing compiling or not, the software 824 contains the instructions to cause the processor 820 to perform the functions.

The camera 828 and the display 830 are configured to capture and display images. The camera 828 can capture images, e.g., of light sources, and provide information about the images to the display. The display 830 is configured to use the information about the images to display the images to a user of the mobile device 812. The camera 828 may be configured to capture images with a low resolution and/or black-and-white images instead of full color images, for example being a dedicated low-resolution light sensor or low-resolution camera that may not be used for photographs. For example, the camera 828 may be configured to capture images with a resolution of no more than 400,000 pixels. The camera 828 may also or alternatively be configured to capture images, e.g., black-and-white images, with a low exposure, e.g., using an exposure duration less than 100 microseconds. The processor 820 (e.g., per the software 824) may be configured to cause the camera 828 to capture black-and-white images, e.g., with no more than 400,000 pixels, and/or to capture images with a low exposure.

The sensors 832 include one or more orientation sensors configured to measure and provide indications of roll and pitch of the mobile device 812, and one or more field sensors configured to measure field vector values. To determine the roll and pitch of the mobile device 812 relative to the reference coordinate system, the sensors 832 include a six-axis gyroscope and an accelerometer. The sensors 832 may be considered to have two orientation sensors (e.g., a first (roll) orientation sensor to obtain an indication of roll and a separate second (pitch) orientation sensor to obtain an indication of pitch) or one sensor (e.g., the first and second orientations sensors being a single sensor, or parts of a single sensor). The reference coordinate system may be a coordinate system of a reference entity such as a building, a coordinate system of the earth, etc. For example, a roll angle may be determined as rotation about a y′-axis of a reference coordinate system 724 of the building 722 shown in FIG. 7 and a pitch angle determined as rotation about an x′-axis of the reference coordinate system 724. The one or more field sensors are configured to measure field values such as magnetic field values (e.g., with one or more magnetometers), and/or radio frequency (RF) field values (e.g., with one or more radio antennas, possibly arranged as an array), and/or acoustic field values (e.g., with one or more microphone receivers, possibly arranged as an array), in magnitude and possibly in direction, that can be converted into components in a coordinate system such as the reference coordinate system 724. The processor 820 is configured to store vector field data 834, either raw data from the one or more field sensors or converted to a coordinate system, in the memory 822.

Referring also to FIG. 9, a mobile device 912, here an example of the mobile device 812, includes a light-receiving module (means for receiving light) 920, an orientation module (means for determining orientation) 922, a transformation module (means for transforming coordinate) 924, a vector field module (means for measuring a vector field) 926, and a positioning module (means for determining position) 928. The modules 920, 922, 924, 926, 928 are functional modules that may be implemented by the processor 820 and the software 824 stored in the memory 822, the camera 828, and/or the sensors 832, as appropriate. Thus, reference to a light-receiving or image capturing function is shorthand for the camera 828, possibly in conjunction with the processor 820 and the software 824 (and/or firmware, and/or hardware of the processor 820), performing the function. The modules 920, 922, 924, 926, 928 are communicatively coupled to each other. Reference to an orientation determination function is shorthand for the orientation sensors, possibly in conjunction with the processor 820 and the software 824 (and/or firmware, and/or hardware of the processor 820), performing the function. Reference to any of the modules 924, 926, 928 performing or being configured to perform a function is shorthand for the processor 820 performing or being configured to perform the function in accordance with the software 824 (and/or firmware, and/or hardware of the processor 820). Similarly, reference to the processor 820 performing a function is equivalent to the light-receiving module 920, the orientation module 922, the transformation module 924, the vector field module 926, and/or the positioning module 928, respectively, performing the function.

The light-receiving module 920 is configured to capture images viewable at the mobile device 912. The module 920 may use the camera 828 to capture images by receiving light and dividing the captured images into pixels. Information may be provided to the processor 820 as to what light signals (e.g., color(s) and/or intensity(ies)) are received by the camera 828 corresponding to the pixels.

The orientation module 922 is configured to take measurements and determine orientation of the mobile device 912. The one or more orientation sensors of the sensors 832 may be used to take measurements from which the orientation module 922 may determine the roll and pitch of the mobile device 912 relative to a reference coordinate system such as a coordinate system of an entity such as a building, or a coordinate system of the earth. Further, the orientation module 922 may process light signals received by the light-receiving module 920 to determine yaw of the mobile device 922, e.g., an angle of the mobile device in a plane tangent to the earth's surface such as the x′-y′ plane of the reference coordinate system 724 shown in FIG. 7 or the reference axes 107 as shown in FIG. 1 (assuming the z-axis of the mobile device 104 is perpendicular to the earth). The orientation module 922 may determine the yaw of the mobile device 912 as discussed above for determining the angle θ shown in FIGS. 2A-2B. For example, knowing the locations of two lights in a captured image, the orientation module 922 may use a line segment connecting the lights as a hypotenuse of a right triangle with a segment of the orientation axis 124 being another side of the triangle, and a third side being perpendicular to the orientation axis 124. The orientation module 922 may determine the length of the line segment connecting the two lights and the length of the line segment of the orientation axis 124 (e.g., in pixels of the captured image), and compute an arccosine using these two lengths to determine the angle θ.

The transformation module 924 is configured determine a transformation of a coordinate system of the mobile device 912 to a reference coordinate system. For example, the reference coordinate system may be the axes 107 shown in FIG. 1 plus an altitude axis normal to the axes 107. As another example, as shown in FIG. 7, the reference coordinate system 724 may be used and an x-y-z coordinate system of the mobile device 712 may be transformed to the x′-y′-z′ reference coordinate system 724 of the building 722. The module 924 is configured to determine a transformation model, e.g., a transformation matrix, that may be used to convert from the mobile device coordinate system to the reference coordinate system and from the reference coordinate system to the mobile device coordinate system. For example, the transformation model may be determined by the module 924 using the determined roll, pitch, and yaw angles relative to the reference coordinate system 724. The transformation model is applicable to the present orientation of the mobile device 912 as determined by the orientation module 922 and thus different orientations will have different transformation models. The module 924 is configured to use standard mathematical techniques to determine the transformation model.

While the mobile device 912 preferably includes the transformation module 924, the mobile device 912, or other examples of the mobile device 712, may not include the transformation module 924, or only a portion of the functionality discussed above. For example, the server 718 may include the transformation module 924 and the mobile device 912 may provide measured field vectors (discussed below) to the server 718 for transformation to the reference coordinate system and may obtain the magnetic field measurements transformed to the reference coordinate system from the server 718.

The vector field module 926 may be implemented by the one or more field sensors of the sensors 832 and is configured to measure a three-dimensional field. For example, the vector field module 926 may be configured to measure the radio frequency (RF) field. Also or alternatively, the vector field module 926 may be configured to measure a three-dimensional magnetic field, i.e., to measure magnetic field components. The module 926, e.g., one or more field sensors, is configured to provide indications of the measured field components to the transformation module 924, e.g., the processor 820 (in conjunction with the memory 822). The transformation module 924 is configured to receive the indications of the measured field components and to transform the measured field from the coordinate system of the mobile device 912 to the reference coordinate system. The transformation module 924 is further configured to transmit the transformed measured field vector in the reference coordinate system to, for example, the server 718 shown in FIG. 7 via the transceiver 826 shown in FIG. 8. The transformation module 924, e.g., the processor 820, may be configured to cause the one or more field sensors to measure the field components.

The positioning module 928 is configured to determine and report the position of the mobile device 912. For example, the module 928 can report the position of the mobile device 912 to the server 718 shown in FIG. 7. The positioning module 928 may determine the position of the mobile device 912 using any of a variety of techniques such as trilateration based on signals received by the light-receiving module 920 from the indicators, here the lights 730, 732 and/or signals received from access points such as the access point 720 shown in FIG. 7. Also or alternatively, the module 928 may be configured to determine the position of the mobile device 912 in conjunction with a satellite positioning system (SPS) module (not shown). The module 928 may also be configured to determine the location of the mobile device 912 by mapping measured field vectors, in the reference coordinate system, provided by the transformation module 924 against a map of field vectors, and determining the location of the mobile device 912 by narrowing the possible locations based on a sequence of the measured vectors. Alternatively, the positioning module 928 may be configured to provide information from which the position of the mobile device 912 may be determined, without the module 928 being configured to determine the position of the mobile device 912. For example, the module 928 may be configured to send information to the server 718 from which the mobile device position may be determined, and to receive information from the server 718 as to the position of the mobile device 912.

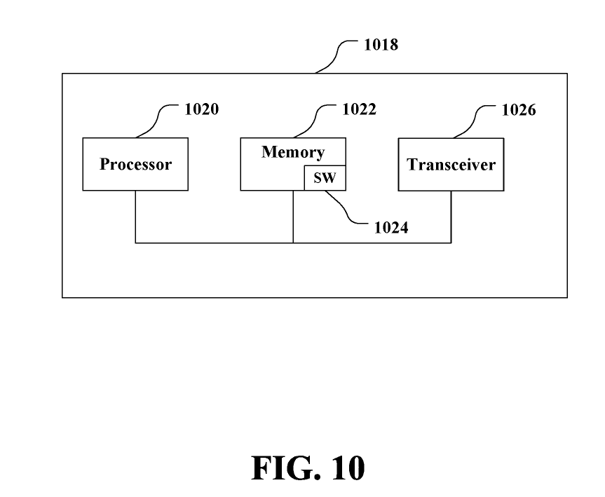

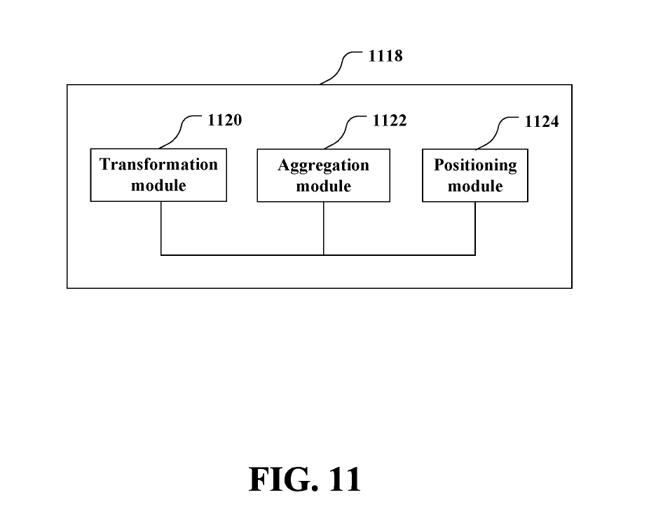

Referring to FIG. 10, with further reference to FIG. 7, a server 1018 comprises a computer system including a processor 1020, a memory 1022 including software 1024, and a transceiver 1026. The server 1018 is an example of the server 718 shown in FIG. 7. The transceiver 1026 is configured to communicate bi-directionally with the network 716. The transceiver 1026 may be configured to communicate with the network 716 wirelessly and/or through one or more wired connections, e.g., with the transceiver 1026 being a wired network interface. The processor 1020 is preferably an intelligent hardware device, e.g., a central processing unit (CPU) such as those made or designed by QUALCOMM®, ARM®, Intel® Corporation, or AMD®, a microcontroller, an application specific integrated circuit (ASIC), etc. The processor 1020 could comprise multiple separate physical entities that can be distributed in the server 1018. The memory 1022 includes random access memory (RAM) and read-only memory (ROM) and preferably long-term memory such as a hard disk drive. The memory 1022 stores the software 1024 which is computer-readable, computer-executable software code containing instructions that are configured to, when performed, cause the processor 1020 to perform various functions described herein, e.g., as discussed with respect to FIGS. 11-12. The software 1024 may not be directly executable by the processor 1020 but configured to cause the processor 1020, e.g., when compiled and executed, to perform the functions. Whether needing compiling or not, the software 1024 contains the instructions to cause the processor 1020 to perform the functions.

Referring also to FIG. 11, with further reference to FIG. 9, a server 1118, here an example of the server 1018, includes a transformation module (means for transforming, means for determining a transformation, means for determining vector components) 1120, an aggregation module (means for aggregating) 1122, and a positioning module (means for obtaining a position) 1124. The modules 1120, 1122, 1124 are communicatively coupled to each other. The modules 1120, 1122, 1124 are functional modules that may be implemented by the processor 1020 and the software 1024 stored in the memory 1022. Reference to any of the modules 1120, 1122, 1124 performing or being configured to perform a function is shorthand for the processor 1020 performing or being configured to perform the function in accordance with the software 1024 (and/or firmware, and/or hardware of the processor 1020). Similarly, reference to the processor 1020 performing a function is equivalent to the transformation module 1120, the aggregation module 1122, and/or the positioning module 1124, respectively, performing the function.

The transformation module 1120 is optional but if included is configured determine a transformation of a coordinate system of the mobile device 912 to a reference coordinate system. The module 1120 is configured to determine a transformation model, e.g., a transformation matrix, that may be used to convert from the mobile device coordinate system to the reference coordinate system and from the reference coordinate system to the mobile device coordinate system. For example, the transformation model may be determined by the module 1120 using determined roll, pitch, and yaw angles of the mobile device 912 relative to the reference coordinate system and provided by the mobile device 912. The transformation model is applicable to the present orientation of the mobile device 912 as determined by the orientation module 922 and thus different orientations will have different transformation models. The module 1120 is configured to use standard mathematical techniques to determine the transformation model. The transformation module 1120 is also, or alternatively, configured to transform measured field values from the coordinate system of the mobile device 912 to the reference coordinate system. If so configured, then the transformation module 1120 is further configured to transmit the measured field vector in the reference coordinate system, e.g., to the aggregation module 1122.

The aggregation module 1122 is configured to accumulate and combine field vectors (sets of three-dimensional field values) in the reference coordinate system. The aggregation module 1122 may combine field vectors associated with related locations, e.g., being associated with each of multiple regions such as map regions that may be defined before and/or after one or more field vectors are measured. The aggregation module 1122 is further configured to combine multiple measurements taken at each of the regions to produce a fingerprint map, and to store the fingerprint map, and optionally to send the fingerprint map to the mobile device 812. For example, referring to FIG. 7, each floor of the building 722 may be divided into multiple regions (i.e., segments), and the aggregation module 1122 can compile measured field vectors in the reference coordinate system 724 of the building 722 for each of these regions to produce a fingerprint map for the respective floor of the building 722 with one composite field vector per region. The composite field vectors may be provided by the transformation module 1120, having been transformed into the reference coordinate system 724 of the building 722 by the module 1120 from raw measurements received from one or more mobile devices, and/or may be provided by one or more mobile devices already in the coordinate system of the building 722. The module 1120 may associate the measured field vectors with regions according to position information associated with the field value sets as provided by the mobile devices and/or as provided by the positioning module 1124. The aggregation module 1120 is configured to combine the received field vectors for each region to determine a single field vector for that region. For example, the module 1120 may be configured to average component values of received three-dimensional magnetic field vectors. Thus, for example, the module 1120 may determine an average x′-component magnetic field value, an average y′-component magnetic field value, and an average z′-component magnetic field value for each region (i.e., predetermined area of a geographic map such as a floor map) in the building 722. The module 1120 may determine a weighted average for each component, for example with more-recently measured vectors, and/or more-reliably measured vectors, receiving greater weights. Still other techniques for determining combined field vectors may be used. The aggregation module 120 may interpolate and/or extrapolate field vectors for a region of a map, e.g., to estimate a field vector at the center of the region of the map. The aggregation module 1122 is configured to associate the combined field vectors corresponding to the building or portions, e.g., floors, of the building 722 to form one or more fingerprint maps, with each fingerprint map being a segmented geographic map preferably having one vector field associated with each region (segment) of the geographic map. Alternatively, related locations could be locations within a threshold distance of each other or of a reference location, such as a location of a measured field vector. For example, field vectors measured within a threshold distance of a predefined location or a selected location (e.g., a location corresponding to a measured field vector), may be combined. In this case, a measured field vector may be used to determine multiple composite field vectors (as may be the case if measured field vectors in the same map region are combined and at least two map regions overlap).

While floors of the building, and the entire building 722, have been used as examples of breadths of fingerprint maps, other combinations of regions may be used for a fingerprint map. If only a single measured field vector is available for a particular region, then the field vector for that region may be the single available measured field vector, and not a combination of measured field vectors. Further, if no measured field vector is available for a region, the fingerprint map may not have data for that region or the aggregation module 1122 may interpolate and/or extrapolate a field vector from other field vectors, e.g., neighboring field vectors. The module 1122 may also or alternatively interpolate and/or extrapolate field vectors to help refine a field vector for a region for which multiple measured field vectors are available. For example, the module 1122 may use interpolation and/or extrapolation to supplement an average field vector where the average field vector is based on fewer than a threshold number of measurements. Further, the aggregation module is configured to transmit the fingerprint map directly or indirectly (e.g., via the network 716, the BTS 714, and/or the AP 720) to the mobile device 912 (or other mobile devices).

The positioning module 1124 is configured to determine and report the position of the mobile device 912. For example, the module 1124 can report the position of the mobile device 912 to the aggregation module 1122 in association with measured field components provided to the module 1122. The positioning module 1124 may determine the position of the mobile device 912 using any of a variety of techniques such as trilateration based on signal information provided by the mobile device 912, e.g., information regarding signals received from access points such as the access point 720 shown in FIG. 7. Also or alternatively, the module 1124 may be configured to determine the position of the mobile device 912 in conjunction with a satellite positioning system (SPS) module (not shown), or by mapping measured field vectors, in the reference coordinate system, provided by the transformation module 1120 or the mobile device 912, against a fingerprint map, and determining the location of the mobile device 912 by narrowing the possible locations based on a sequence of the measured vectors.

Referring to FIG. 12, with further reference to FIGS. 1-2 and 7-11, a process 1200 of determining data of a fingerprint map includes the stages shown. The fingerprint map may be of an indoor environment such as the building 722 or a floor thereof. The process 1200 is, however, an example only and not limiting. The process 1200 can be altered, e.g., by having stages added, removed, rearranged, combined, performed concurrently, and/or having single stages split into multiple stages. For example, stage 1224 may be omitted. Still other alterations to the process 1200 are possible. For the discussion below of the process 1200, reference is made to the mobile device 712, of which the mobile device 812 is an example, of which the mobile device 912 is an example. Thus, reference is made to components of the mobile devices 812, 912.

At stage 1212, the process 1210 includes obtaining visible light communication signals at a mobile device. The camera 828 may capture visible light communication signals in a field of view of a lens of the camera 828, and preferably in the vicinity of the mobile device 812. For example, the camera 828 may capture images of light from one or more of the lights 730, 732 or from one or more of the indicators 108, 110, 112, 114, 116, 118, 120, 122.

At stage 1214, the process 1210 includes determining an indication of yaw of the mobile device relative to a reference coordinate system using the visible light communication signals. As discussed above, for example with respect to FIG. 2B, the mobile device 912, e.g., the orientation module 922 of the mobile device 912, may determine the yaw of the mobile device 912 relative to a reference coordinate system such as relative to the x′-y′ plane of the building 722.

At stage 1216, the process 1210 includes obtaining an indication of roll of the mobile device relative to the reference coordinate system. For example, a roll orientation sensor of the sensors 832 may be used to measure orientation of the mobile device 812 and provide an indication of the roll of the mobile device relative to a reference coordinate system such as the reference coordinate system 724 of the building 722.

At stage 1218, the process 1210 includes obtaining an indication of pitch of the mobile device relative to the reference coordinate system. For example, a pitch orientation sensor of the sensors 832 may be used to measure orientation of the mobile device 812 and provide an indication of the pitch of the mobile device 812 relative to a reference coordinate system such as the reference coordinate system 724 of the building 722.

At stage 1220, the process 1210 includes determining a transformation of a mobile-device coordinate system of the mobile device to the reference coordinate system using the indication of roll, the indication of pitch, and the indication of yaw of the mobile device relative to the reference coordinate system. For example, the transformation module 924 of the mobile device 912 uses the roll, pitch, and yaw information provided by the orientation module 922 in order to calculate a transformation model for converting coordinates and vectors in the mobile-device coordinate system to vectors in the reference coordinate system such as the reference coordinate system 724. Alternatively, some or all of these calculations may be performed at the server 718 by the transformation module 1120 of the server 1118.

At stage 1222, the process 1210 includes obtaining first indications of vector components of a field at a location of the mobile device, the vector components defining the field. For example, the vector field module 926 measures a field, such as a magnetic field. The vector field module 926 provides component values for a vector of the magnetic field, for example the module 926 measures and provides an x-component value, a y-component value, and a z-component value for vector components in the x-y-z coordinate system of the mobile device 912. The vector components define the field in that they indicate the component values of the field.

At stage 1224, the process 1210 optionally includes obtaining a location of the mobile device corresponding to the first indications of vector components of the field. For example, the positioning module 928 (and/or the positioning module 1124) determines what the location of the mobile device 912 was at or about the time that the vector field was measured so that an association of the measured vector field with the location of the mobile device 912 can be determined. If stage 1224 is omitted, the measured field vector can be used, e.g., combined with other measured field vectors without the precise knowledge of the location for the measured field vector that may be provided by the positioning module. For example, measured field vectors measured close together in time may be assumed to be at the same location or within a threshold distance of each other, and therefore combined.

At stage 1226, the process 1210 includes sending, to a server, the first indications of vector components of the field and the transformation; or determining second indications of vector components of the field using the first indications of vector components of the field and the transformation, the second indications of vector components of the field being indicative of vector components of the field at the location of the mobile device in the reference coordinate system, and sending, to the server, the second indications of vector components of the field; or sending the first indications of vector components of the field to the server, determining the second indications of vector components of the field using the first indications of vector components of the field and the transformation, and sending the second indications of vector components of the field to the server. For example, with the first option, the processor 820 and the transceiver 826 may send indications of vector components of the field in the mobile device coordinate system and the transformation to the server 718. As an example of the second option, the transformation module 924 converts the vector components of the field (the x-component, the y-component, and the z-component) from the mobile device coordinate system to the reference coordinate system, e.g. the reference coordinate system 724, and the processor 820 and the transceiver 826 may send the converted components to the server 718. Alternatively, some or all of this transformation may be performed by the transformation module 1120 of the server 1118. As an example of the third option, the processor 820 and the transceiver 826 may send indications of vector components of the field in the mobile device coordinate system to the server 718 and the transformation module 924 may convert these components to the reference coordinate system and send the converted components to the server 718.

Information may be sent to the server 1118, in raw or processed form, so that the server 1118 can compile information to form the fingerprint map. The entire process 1210, or a portion thereof, may be performed by the server 1118. For example, stages 1220, 1222, and 1226 may be performed by the server 1118. If the server performs the stages 1212, 1216, 1218, then the obtaining in stages 1212, 1216, 1218 comprises receiving indications of the visible light communications, roll, and pitch from the mobile device 912. As an example regarding stages 1222, 1226, the first indications of vector components may be sent to the server 1118 if the server 1118 is to transform the first indications into the second indications, and the server 1118 can perform the determining of stage 1226. Alternatively, some or all of the second indications may be determined by the mobile device 912 and sent to the server 1118. Further, the location of the mobile device 912, if determined by the mobile device 912, may be sent to the server 1118 at stage 1224 in association with the first indications and/or the second indications, i.e., indications of the vector field either in raw or transformed form.

The process 1210 may further include, or another process may include, combining the second indications of vector components of the field at the location of the mobile device with other second indications of vector components of the field with a location related to the location of the mobile device, e.g., within a common segment of a map as the mobile device, within a threshold distance of the mobile device, etc., to determine aggregate indications of vector components of the field associated with the location of the mobile device to produce a fingerprint map. For example, for each segment of a map, the aggregation module 1122 may average field vectors from multiple measurements from one or more mobile devices. The process 1210, or another process, may further include combining the aggregate indications of vector components of the field in one region with aggregate indications of vector components of the field at other regions to form a fingerprint map for a venue. For example, the aggregation module 1122 may determine a vector field (by averaging, weighted averaging, interpolating, extrapolating, etc.) for each region of a map. The process 1210, or another process, may further include transmitting the fingerprint map for the venue to one or more mobile devices, whether field vector measurements were received from the mobile device or not, directly or indirectly (e.g., by transmitting the map to an entity configured to communicate with mobile devices to provide the fingerprint map to the mobile devices).

In order to determine a position of the mobile device, portions of the process 1210 may be performed. An example of a position-determining process may include the stages of the process 1210 except for the stage 1220, with the stage 1220 having been performed previously or a transformation model otherwise obtained, e.g., provided. Further, the example process may further include comparing the vector components of the field of multiple measurements to vector components of the field of a fingerprint map. The fingerprint map may have already been obtained or provided, e.g., by the server 1018, or may be obtained as part of the positioning process. For example, the positioning module 928 may compare multiple sequential field vectors in the reference coordinate system, as provided by the transformation module 926, to the fingerprint map. The positioning module 928 may determine a location of the mobile device 912 based on one or more probabilities of one or more possible locations based on the sequence of field vectors, e.g., the position being the end position of a sequence in the fingerprint map matching the measured sequence of field vectors, or the position being the end position of a sequence in the fingerprint map, of multiple possible sequences, that most closely matches (e.g., has the smallest deviation or error relative to) the measured sequence of field vectors.

The process 1210 or a portion thereof, such as the stage 1126, may be triggered by one or more criteria. For example, the process 1210 or the stage 1226 may be triggered in response to the passage of a threshold amount of time, and/or in response to movement of the mobile device 812 more than a threshold distance (e.g., as determined by an accelerometer of the sensors 832 and the processor 820), and/or in response to a location uncertainty and/or a location error exceeding a corresponding threshold, and/or in response to entering and/or exiting a region. One or more other criteria may also or alternatively be used to trigger one or more operations.

Other Considerations

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” “A, B, C, or any combination thereof,” and “one or more of A, B, or C” include any combination of A, B, and/or C, and may include multiples of A, multiples of B, and/or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C (e.g., AAB, AAC, ABBC, etc.). All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

As used herein, including in the claims, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include that the information is conveyed from a sending entity but does not reach an intended recipient of the information. The intended recipient, even if not actually receiving the information, may still be referred to as a receiving entity, e.g., a receiving execution environment.

Due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Components, functional or otherwise, shown in the figures and/or discussed herein as being connected or communicating with each other are communicatively coupled. That is, they may be directly or indirectly connected to enable communication between them.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

What is claimed is:

1. A method of determining data of a magnetic field fingerprint map, the method comprising:
determining, at a server, a transformation of a mobile-device coordinate system of a mobile device to a reference coordinate system using roll information, pitch information, and yaw information of the mobile device relative to the reference coordinate system;
obtaining, at the server, first indications of vector components of a magnetic field at a location of the mobile device, the first indications of vector components of the magnetic field being in the mobile-device coordinate system; and
determining, at the server, second indications of vector components of the magnetic field using the first indications of vector components of the magnetic field and the transformation, the second indications of vector components of the magnetic field being indicative of vector components of the magnetic field at the location of the mobile device in the reference coordinate system.

2. The method of claim 1, further comprising combining the second indications of vector components of the magnetic field at the location of the mobile device with other second indications, from other mobile devices, of vector components of the magnetic field associated with a region including the location of the mobile device to determine aggregate indications of vector components of the magnetic field associated with the region including the location of the mobile device.

3. The method of claim 2, further comprising:
combining the aggregate indications of vector components of the magnetic field at the location of the mobile device with aggregate indications of vector components of the magnetic field at other locations to form the magnetic field fingerprint map for a venue; and
transmitting the fingerprint map for the venue to at least one of at least one mobile device or an entity configured to communicate with mobile devices to provide the fingerprint map to the mobile devices.

4. The method of claim 1, wherein the first indications of vector components of the magnetic field include an indication of an x-component, an indication of a y-component, and an indication of a z-component of the magnetic field in the mobile-device coordinate system, and the second indications of vector components of the magnetic field include an indication of an x-component, an indication of a y-component, and an indication of a z-component of the magnetic field in the reference coordinate system.

5. A server comprising:
a transceiver;
a memory; and
a processor communicatively coupled to the transceiver and the memory and configured to:
determine a transformation of a mobile-device coordinate system of a mobile device to a reference coordinate system using roll information, pitch information, and yaw information of the mobile device relative to the reference coordinate system;
obtain, via the transceiver, first indications of vector components of a magnetic field at a location of the mobile device, the first indications of vector components of the magnetic field being in the mobile-device coordinate system; and
determine second indications of vector components of the magnetic field using the first indications of vector components of the magnetic field and the transformation, the second indications of vector components of the magnetic field being indicative of vector components of the magnetic field at the location of the mobile device in the reference coordinate system.

6. The server of claim 5, wherein the processor is further configured to combine the second indications of vector components of the magnetic field at the location of the mobile device with other second indications, from other mobile devices, of vector components of the magnetic field associated with a region including the location of the mobile device to determine aggregate indications of vector components of the magnetic field associated with the region including the location of the mobile device.

7. The server of claim 6, wherein the processor is further configured to:
combine the aggregate indications of vector components of the magnetic field at the location of the mobile device with aggregate indications of vector components of the magnetic field at other locations to form a fingerprint map for a venue; and
transmit the fingerprint map for the venue to at least one of at least one mobile device or an entity configured to communicate with mobile devices to provide the fingerprint map to the mobile devices.

8. The server of claim 5, wherein the first indications of vector components of the magnetic field include an indication of an x-component, an indication of a y-component, and an indication of a z-component of the magnetic field in the mobile-device coordinate system, and the second indications of vector components of the magnetic field include an indication of an x-component, an indication of a y-component, and an indication of a z-component of the magnetic field in the reference coordinate system.

9. A server comprising:
first determining means for determining a transformation of a mobile-device coordinate system of a mobile device to a reference coordinate system using roll information, pitch information, and yaw information of the mobile device relative to the reference coordinate system;
means for obtaining first indications of vector components of a magnetic field at a location of the mobile device, the first indications of vector components of the magnetic field being in the mobile-device coordinate system; and
second determining means, communicatively coupled to the means for obtaining and the first determining means, for determining second indications of vector components of the magnetic field using the first indications of vector components of the magnetic field and the transformation, the second indications of vector components of the magnetic field being indicative of vector components of the magnetic field at the location of the mobile device in the reference coordinate system.

10. The server of claim 9, further comprising means for combining the second indications of vector components of the magnetic field at the location of the mobile device with other second indications, from other mobile devices, of vector components of the magnetic field associated with a location including the location of the mobile device to determine aggregate indications of vector components of the magnetic field associated with the region including the location of the mobile device.

11. The server of claim 10, further comprising:
means for combining the aggregate indications of vector components of the magnetic field at the location of the mobile device with aggregate indications of vector components of the magnetic field at other locations to form a fingerprint map for a venue; and
means for transmitting the fingerprint map for the venue to at least one of at least one mobile device or an entity configured to communicate with mobile devices to provide the fingerprint map to the mobile devices.

12. The server of claim 9, wherein the first indications of vector components of the magnetic field include an indication of an x-component, an indication of a y-component, and an indication of a z-component of the magnetic field in the mobile-device coordinate system, and the second indications of vector components of the magnetic field include an indication of an x-component, an indication of a y-component, and an indication of a z-component of the magnetic field in the reference coordinate system.

13. A non-transitive, processor-readable storage medium comprising processor-readable instructions configured to cause a processor to:
determine a transformation of a mobile-device coordinate system of a mobile device to a reference coordinate system using roll information, pitch information, and yaw information of the mobile device relative to the reference coordinate system;
obtain first indications of vector components of a magnetic field at a location of the mobile device, the first indications of vector components of the magnetic field being in the mobile-device coordinate system; and
determine second indications of vector components of the magnetic field using the first indications of vector components of the magnetic field and the transformation, the second indications of vector components of the magnetic field being indicative of vector components of the magnetic field at the location of the mobile device in the reference coordinate system.

14. The storage medium of claim 13, further comprising instructions configured to cause the processor to combine the second indications of vector components of the magnetic field at the location of the mobile device with other second indications, from other mobile devices, of vector components of the magnetic field associated with a region including the location of the mobile device to determine aggregate indications of vector components of the magnetic field associated with the region including the location of the mobile device.

15. The storage medium of claim 14, further comprising instructions configured to cause the processor to:
combine the aggregate indications of vector components of the magnetic field at the location of the mobile device with aggregate indications of vector components of the magnetic field at other locations to form a fingerprint map for a venue; and
transmit the fingerprint map for the venue to at least one of at least one mobile device or an entity configured to communicate with mobile devices to provide the fingerprint map to the mobile devices.

16. The storage medium of claim 13, wherein the first indications of vector components of the magnetic field include an indication of an x-component, an indication of a y-component, and an indication of a z-component of the magnetic field in the mobile-device coordinate system, and the second indications of vector components of the magnetic field include an indication of an x-component, an indication of a y-component, and an indication of a z-component of the magnetic field in the reference coordinate system.
